(19) United States
(12) Patent Application Publication
(10) Pub. No.: US 2002/0106608 A1
(43) Pub. Date: Aug. 8, 2002

(54) Dental/medical prophylaxis device with sterilizable components

(76) Inventors: David Pollock, York, PA (US); Matthew Barto, Dover, PA (US)

Correspondence Address: DENTSPLY INTERNATIONAL INC., 570 West College Avenue, York, PA, 17405-0872, US

(21) Appl. No.: 09/993,083

(22) Filed: Nov. 5, 2001

Related U.S. Application Data
(60) Provisional application No. 60/246,271, filed on Nov. 7, 2000.

(51) Int. Cl. A61C 3/03; A61C 3/02

(52) U.S. Cl. 433/119; 433/88

(57) ABSTRACT

A dental prophylaxis device (10) has a drive unit (11) a removable connecting cable (12) and a removable handpiece (13) which can be employed with an air polishing insert (15) or alternatively, an ultrasonic scaling insert (14). By removing the handpiece (13) from its insert (14, 15) and it cable (12), handpiece 13 can be sterilized in a conventional manner.

### BACKGROUND OF THE INVENTION

1. Field of the Invention

The present invention relates to dental or medical prophylaxis equipment. More particularly, the invention selectively provides prophylactic scaling and air polishing in a device having sterilizable components. The sterilizable components include a handpiece containing an interior electrical winding and a pressurized gas-entrained powder conduit, which handpiece is for use in treating mammals. More particularly the present invention relates in a preferred embodiment to ultrasonic dental/medical hand tools and more especially to an ultrasonic/abrasive polishing dental handpiece combination, which can withstand the rigors of multiple cycles of sterilization using any of a number of currently widely used sterilization methods and equipment including autoclaving, dry heat at 190. degree. C. and chemical, without unacceptable detrimental effects to the handpiece.

2. Description of the Prior Art

Ultrasonic dental handpieces employed during dental procedures for cutting or cleaning are well known. One such example is U.S. Pat. No. 4,492,574 to Warnin et al., which teaches an ultrasonic endodontic dental handpiece having a coil for establishing an alternating magnetic field, the housing having a cooling fluid inlet at one end and being open at the other end for receiving and supporting a removable insert.

U.S. Pat. No. 3,882,638 to Black describes an air-abrasive prophylactic device for dental use. U.S. Pat. No. 5,395,240 discloses a sterilizable dental/medical handpiece containing an electric coil for ultrasonic scaling.

Today, cross contamination has become a major concern in the medical and dental fields. Bacteria and viruses from one patient's mouth can be transferred to another patient if the handpiece is not adequately sterilized. Therefore, sterilization of dental instruments has become mandatory. However, due to the sensitive nature of the electrical and mechanical components involved with ultrasonic and air-abrasive handpieces, sterilization of the entire handpiece was previously limited.

Prior to this invention the more usual method used to cleanse and disinfect ultrasonic and air-abrasive handpieces was to wipe the exterior of the handpiece using a disinfecting solution. Where autoclaving was alleged to be acceptable, its use was limited to handpieces of simpler design having only heavy gauge wire windings.

In many prior art ultrasonic scaling handpieces a coil of conductive wire within the handpiece was connected permanently by a cable to a power source. An oscillating current within the coil in the handpiece produced a magnetic field to induce motion within a magnetostrictive element separable and removably inserted within the magnetic field within the handpiece. The magnetostrictive element was connected by a metal body to a dental tool which was caused to vibrate at ultrasonic speeds to clean and reduce teeth, calculus, cartilage and bone. High temperature and steam sterilization methods were not suitable for sterilizing these handpieces because they would cause short-circuiting in the coils and connections and degradation of mechanical parts, resulting in impractically short useful life.

The present invention has overcome the problems encountered in the art by providing a handpiece for ultrasonic scaling, air-abrasive polishing, or preferably both, which is removed from the cable, at least partially disassembled, and effectively sterilized by any conventional method such as autoclave and other steam sterilization techniques, high temperature dry sterilization, Chemiclave.RTM., and using other liquid sterilants at room and elevated temperatures. The invention is broadly applicable to dental/medical handpieces of diverse uses including handpieces such as for dental scalers, medical scalers, endodontic, orthopedic and nasal medical handpieces, air-abrasive polishers, and combinations thereof. The preferred embodiment of the invention is in dental handpieces.

While described in detail in its most preferred embodiment of a dental handpiece the present invention is directly applicable to other dental, medical and veterinary tools having electric coils, air-abrasive elements, or both, proximate to a patient so that superior sterilization is indicated by good dental, medical or veterinary practice.

### SUMMARY OF THE INVENTION

The present invention in a preferred embodiment selectively provides an ultrasonic and air-abrasive polishing handpiece which can be sterilized by any of a number of conventional methods when disassembled, without excessive detrimental effects to any of the handpiece components. The handpiece has been specifically constructed in a preferred embodiment to include a housing member or sleeve and a coil unit, pressurized gas-entrained powder or particulate conduits and pressurized water (or other liquid medicant) conduits, and electrical conductors. The handpiece can be disconnected from the cable attaching it to the base drive unit, which unit provides for control and direction of electrical current, pressurized liquid and gas to the hanpiece. The cable can also be disconnected from the drive unit. Other objects and advantages of the present invention will become apparent from the following detailed description when viewed in conjunction with the accompanying drawings, which set forth certain embodiments of the invention.

### BRIEF DESCRIPTION OF THE DRAWINGS

FIG. 1 is a perspective, exploded view of a prophylactic device according to the present invention, showing a base drive unit, a connecting cable assembly, a handpiece housing and two alternative inserts, one for abrasive polishing and one for ultrasonic scaling.

FIG. 2 is an end view of the connecting cable of FIG. 1.

FIG. 3 is an end view of the connecting cable of FIG. 1, and being the opposite end of that shown in FIG. 2.

FIG. 4 is an end view of the handpiece housing shown in FIG. 1.

FIG. 5 is an end view of the handpiece housing shown in FIG. 1, and being the opposite end of that shown in FIG. 4.

FIG. 6 is a perspective, exploded view of a prophylactic device according to the present invention, showing a base drive unit, a connecting cable assembly, a handpiece housing and an alternative abrasive polishing insert to that shown in FIG. 1, and not having an ultrasonic scaling capability.

### PREFERRED EMBODIMENTS FOR CARRYING OUT THE INVENTION

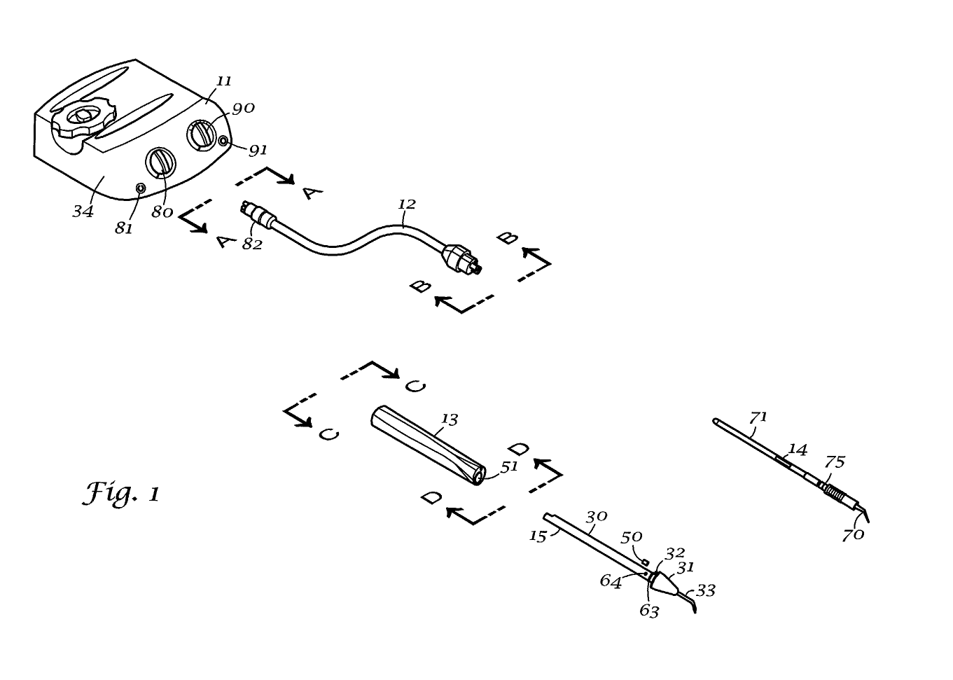

There is shown in FIG. 1, a prophylactic device 10 according to the present invention. Prophylactic device 10 includes a base drive unit 11, a connecting cable 12 fluidly and electrically coupled to a handpiece 13. Handpiece 13 is configured to operatively receive at least one of and preferably selectively both, an ultrasonic scaling insert 14 and an air polishing insert 15. Drive unit 11 can be substantially similar to conventional drive units known in the art, as long as it provides electricity and/or pressurized liquid and gas streams to the handpiece 13. An exemplary drive unit is found in for example, U.S. Pat. No. 5,125,837, which is hereby incorporated by reference for such disclosure.

Handpiece 13 with its preferred and associated insert 14 provides for ultrasonic scaling operations, and for air polishing operations when associated insert 15 is employed. Air polishing inserts such as insert 15 are sometimes referred to in the art as “prophy nozzles.”

Preferably, the inventive device 10 also provides for the delivery of a pressurized fluid stream for cleaning fluids, medicants or the like. As such, handpiece 13, as shown in FIG. 4, has internal conduits electrically or fluidly communicating through cable assembly 12 to drive unit 11. More preferably, handpiece 13 includes electrical contacts 20, 21 and 22, a water conduit 23 and a pressurized gas conduit 24 (FIG. 4).

A conventional coil 25 (FIG. 5) is employed within handpiece 13 for establishing an alternating magnetic field about ultrasonic scaling insert 14. The coil is driven by electricity supplied by electrical contacts 20, 21 and 22. The operation of both an air polishing device and an ultrasonic scaling device are known in the art. For example, equipment and methods for delivering an abrasive-laden gas stream are shown in U.S. Pat. No. 4,412,402, which is hereby incorporated by reference for such disclosure. Similarly, an ultrasonic dental handpiece is shown in U.S. Pat. No. 4,492,574 and No. 5,395,240, which are hereby incorporated by reference for such disclosure. The details of the operation of an ultrasonic scaler and an air polisher are conventional except as provided herein, and need not be further explained.

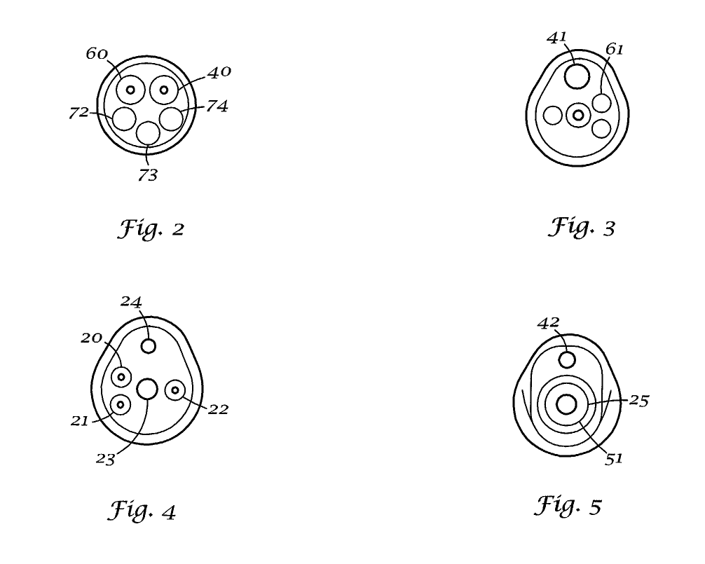

A preferred air polishing insert 15 has an insert body 30, a working head assembly 31 and an entrained particle/pressurized gas input 32. Working head assembly 31 has a powder delivery nozzle 33 from which the pressurized gas with entrained powder (not shown) exits and is directed toward a work piece (not shown) in an otherwise conventional manner. Drive unit 11 is preferably configured to provide a source of the pressurized gas, preferably air, and a reservoir of powder 34 which mixes with the pressurized gas. Drive unit 11 then causes this entrained powder/gas combination to pass through cable assembly 12. As shown in FIG. 2, cable assembly 12 has an air/powder input 40 and as shown in FIG. 3, it has an air/powder output conduit 41.

The air/powder output 41 of cable assembly 12 fluidly seals and communicates with air/powder input 24 of handpiece 13. Further, handpiece 13 also has an internal conduit (not shown) that fluidly communicates with air/powder output 42 of handpiece 13. Input 32 of working head assembly 31 also fluidly communicates with air/powder output 42 such that the powder entrained pressurized gas stream is caused to flow to delivery nozzle 33. In order to ensure a substantially fluid tight seal between air/powder output 42 and input 32, an elongated, preferably elastomeric or plastic tube seal 50 is provided. Seal 50 is preferably configured such that it has a tight, physical friction fit both with the outside of input 32 and with the inside of air/powder output 42. It is to be appreciated that to disassemble handpiece 13, insert 15 can be removed as can seal 50. Handpiece 13 can then be sterilized. Seal 50 can be sterilized or easily replaced as needed.

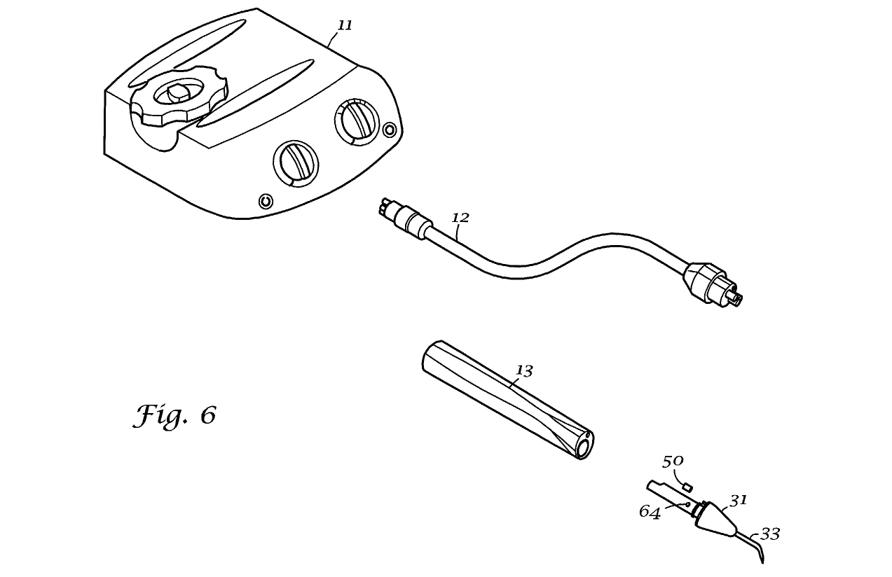

To assemble handpiece 13, body 30 of insert 15 is inserted into insert receiving aperture 51 of handpiece 13. Body 30 need be of no particular size, and as shown between FIGS. 1 and 6, can be of differing sizes. In this way, the weight of handpiece 13 with it associated insert may be adjustable for a particular purpose or desire.

As is the case with air polishing, a water source can supplied by drive unit 11, to travel through water input 60 of cable 12 with which it fluidly communicates. The water, preferably pressurized, is then caused to exit cable 12 through its water output 61 which is in fluid communication with input 60 and with input 23 of handpiece 13. The water would then flow through the hollow interior aperture 51 of handpiece 13. Working head 31 effectively fluidly seals aperture 51, such as by use of an o-ring 63. A water input aperture 64 is provided in body 30, which aperture 64 is in fluid communication with working head 31, thereby supplying pressurized water to working head 31. It will be appreciated that a similar water delivery system can be employed with ultrasonic scaler insert 14, if insert 14 is of the type to employ water, such as the FocusedSpray insert available from Dentsply International Inc. or York, Pa.

When handpiece 13 is employed in ultrasonic scaling operations, an insert 14 is employed. Insert 14 has a working end 70 and a magnetic field receiving body 71. Body 71 is received within aperture 51 of handpiece 13. Drive unit 11 provides for electricity through electrical contacts 72, 73 and 74 of cable 12 which are electrically connected thereto and to electrical contacts 20, 21 and 22 of handpiece 13. As is conventional, scaling insert 14 is also provided with a sealing o-ring 75.

It will be appreciated, that handpiece 13 can be used in selectively, an ultrasonic scaling mode with the use of insert 14, or in an air polishing mode with the use of insert 15. It will also be appreciated that handpiece 13 can be effectively removed from cable 12 and from its associated insert 14 or 15. Handpiece 13 can then be sterilized in any conventional manner. The electrical contacts made between drive unit 11 and cable 12, as well as between cable 12 and handpiece 13, can be any conventional contact as long as it is removable. Similarly, the fluid communication between drive unit 11 and cable assembly 12 air/powder and water input can be conventional but are preferably removable. Similarly again, the fluid communication between cable 12 outputs 41 and 61 are preferably removable, but otherwise conventional, with the inputs of handpiece 13.

Drive unit 11 is exemplified in the drawings as being a countertop model supplying electricity, water and air/powder in the manner described. It is also to be appreciated that these supplies may be made by any means, including direct connection to source supplies, such as utility electrical and water, a compressor, or from any other type of unit, such as a dental operatory, dental chair or the like.

When drive unit 11 is employed, it will normally be provided with a control 80 for controlling ultrasonic scaling operations, and as such will have a connector 81 for supplying electricity in the manner above described. Connector 81 operatively and removably mates with cable connector 82 of cable 12. Similarly, when used in air polishing operations, a control 90 is employed for controlling the air/powder and/or the water delivery requirements through a connector 91 which also operatively and removably communicates with connector 82 of cable 12.

FIG. 6 shows an alternative embodiment of the sterilizable handpiece 13, wherein this handpiece is configured without electrical contacts and provides only for air polishing. Although not shown, a similar device within the scope of this invention would provide only for ultrasonic scaling and not for air polishing. All such embodiments, when used with the sterilizable handpiece 13 of the present invention are within the scope of this invention

As shown in FIGS. 1 and 6, handpiece 13 is preferably configured with unique curvatures to make the handpiece 13 more ergonomic and to reduce user fatigue. For example, curvilinear surfaces 100, 101 and 102 may be provided to facilitate gripping in this manner. Handpiece 13 can be manufactured from any sterlizable and otherwise conventional material. Nylon 66, and more particularly, glass filled nylon 66 is preferred.

It is apparent therefore, that a sterilizable prophylaxis device is provided according to the invention disclosed and described herein. The invention has been exemplified with reference to drawings without attempting to show all of the variations that fall within the scope of the invention. All such variations are within the scope of the invention.

We claim:

1. A sterilizable dental device used with a base drive unit of the type supplying electricity and pressurized gas having entrained particulate therein to the device through a connecting cable, the device alternately and selectively functioning as an ultrasonic handpiece and as an air-abrasive polishing handpiece by selectively and operatively receiving an ultrasonic insert and an air-abrasive polishing insert, comprising a housing member and a coil unit, pressurized gas-entrained particulate conduits and pressurized fluid conduits , such that when the device receives the ultrasonic insert, said coil is in electrical, operative driving communication therewith, and when the device receives the air-abrasive polishing insert, said particulate conduits are in fluid communication therewith; the connecting cable being removable from the device and from the base drive unit.
